(19) United States
(12) Patent Application Publication
(10) Pub. No.: US 2007/0281055 A1
(43) Pub. Date: Dec. 6, 2007

(54) Protein Ingredient with Improved Sensory Quality and Nutritionals with Improved Flavor Containing Same

(76) Inventors: Gaurav C. Patel, Gahanna, OH (US); Paul W. Johns, Columbus, OH (US); Susan M. Fawcett, Columbus, OH (US); Robert L. Joseph, Columbus, OH (US); Louis I. Ndife, Columbus, OH (US); Rosalyn R. Phillips, Bexley, OH (US); Eric M. Himmelreich, Westerville, OH (US)

Correspondence Address: ROSS PRODUCTS DIVISION OF ABBOTT LABORATORIES;DEPARTMENT 108140-DS/1, 625 CLEVELAND AVENUE, COLUMBUS, OH, 43215-1724, US

(21) Appl. No.: 11/756,844

(22) Filed: Jun. 1, 2007

Related U.S. Application Data
(60) Provisional application No. 60/810,422, filed on Jun. 2, 2006.

(51) Int. Cl. A23L 1/30

(52) U.S. Cl. 426/72

(57) ABSTRACT

Disclosed are food products comprising a clean milk protein and/or other clean protein ingredients, and one or more other food ingredients, wherein the food product has a concentration of off-note contaminant markers (OCM) per kg of milk protein of 1100 μg or less, and/or a concentration of off-note contaminant markers (OCM) per kg of soy protein of 1001 mg or less. Also disclosed is a water washing method for producing clean milk protein that may be used in food products.

This application claims the benefit of U.S. Provisional Application No. 60/810,422 filed Jun. 2, 2006

### FIELD OF THE INVENTION

The present invention relates to a protein containing nutritional product having improved flavor.

### RELATED ART

A common problem with the use of shelf-stable milk protein ingredients in nutritional products is the presence of off-notes. For example, the commonly used milk protein ingredients nonfat dry milk (NFDM), condensed skim milk, acid casein and caseinates often exhibit barny or cowy flavors. Therefore, there exists a need for milk protein ingredients and nutritional products containing milk protein ingredients that do not exhibit such off flavor.

### SUMMARY

According to a first broad aspect of the present invention, there is provided a food product comprising: milk protein; and one or more other food ingredients, wherein the food product contains 1100 μg or less of off-note contaminant markers per kg of milk protein.

According to a second broad aspect of the invention, there is provided a method comprising the following steps: (a) providing an impure ingredient comprising milk protein and one or more milk protein off-note contaminants; and (b) water washing the impure ingredient to thereby form a purified food ingredient containing less than 1100 μg or less of off-note contaminant markers per kg of milk protein, wherein the impure product contains more than 1100 μg of off-note contaminant markers per kg of milk protein.

According to a third broad aspect of the present invention, there is provided a food product comprising: soy protein; and one or more other food ingredients, wherein the food product contains 1001 μg or less of off-note contaminant markers per kg of soy protein.

### BRIEF DESCRIPTION OF THE DRAWINGS

FIG. 1 is a graph showing that the indoxyl sulfate content of milk protein concentrate (MPC) decreases as the protein content increases as the indoxyl sulfate is extracted from MPC.

FIG. 2 is a graph showing total 4-cresol content vs protein content for milk protein concentrate (MPC) lots; R-square 0.998, 3 points, y=62.8+(−0.74x).

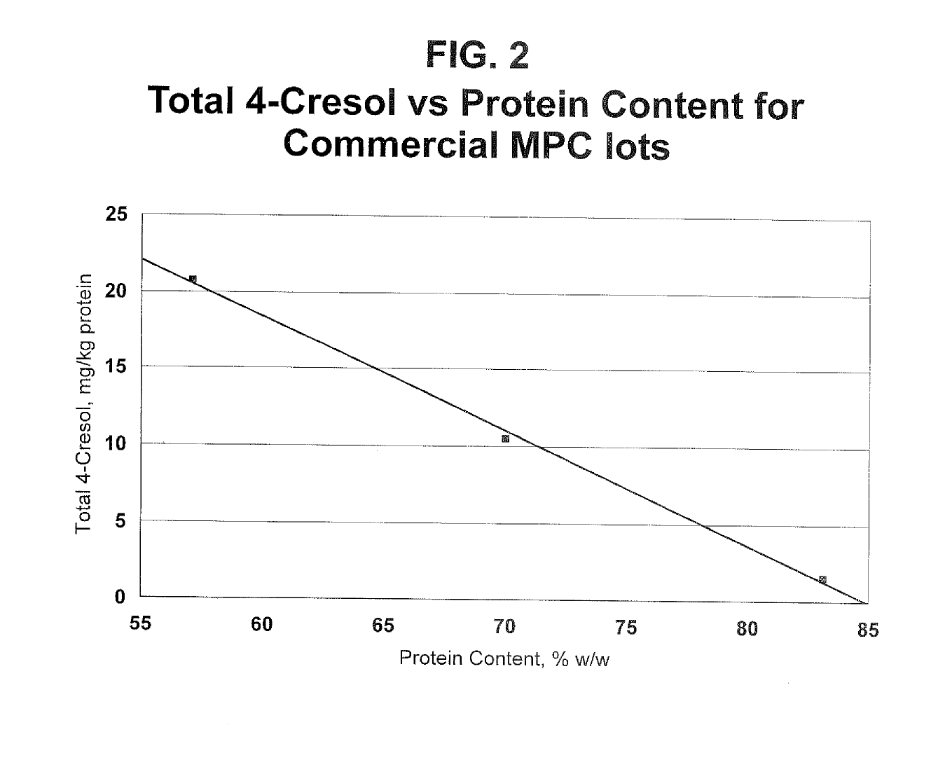

### DETAILED DESCRIPTION

It is advantageous to define several terms before describing the invention. It should be appreciated that the following definitions are used throughout this application.

Definitions

Where the definition of terms departs from the commonly used meaning of the term, applicant intends to utilize the definitions provided below, unless specifically indicated.

For the purposes of the present invention, the term “clean milk protein” refer to milk protein having 10% or less of the off-note contaminant markers (OCM) found in non-purified milk protein. In one embodiment of the present invention, clean milk protein contains less than 1000 μg of total p-cresol (free p-cresol+conjugate-bound p-cresol) per kg of milk protein and less than 100 μg of free indole per kg of milk protein.

For the purposes of the present invention, the term “clean protein ingredients” refer to any non-milk protein ingredient having 50% or less of the off-note contaminant markers (OCM) found in a non-purified form of the protein

For the purposes of the present invention, the term “clean soy protein” refer to soy protein having 50% or less of the off-note contaminants found in non-purified soy protein. In one embodiment of the present invention, clean soy protein contains less than 100 μg of indole per kg of soy protein and less than 1000 μg of p-cresol per kg of soy protein and less than 1000 mg of isoflavones per kg of soy protein.

For the purposes of the present invention, the term “cresol” refers to p-cresol and conjugates thereof, or mixtures of conjugates thereof. Examples of cresol conjugates are cresol sulfate, cresol glucuronate, etc.

For the purposes of the present invention, the term “food additive” refers to the common meaning of the term “food additive” and includes any product classified as a “food additive” by the U.S. Food and Drug Administration. Food additives may include non-caloric sweeteners, colorants, bulking agents (e.g., polydextrose), fat substitutes such as olestra, etc.

For the purposes of the present invention, the terms “food”, “food ingredient” or “food product” refer to the common meaning of these terms and include any product classified as a “food” by the U.S. Food and Drug Administration. Food products may include any product that may be directly drunk or ingested or that may be further mixed with other ingredients, further processed, etc., to form a product that may be drunk or ingested. For example, a food product may be mixed with a liquid to form a drink, added to flour and baked to form a bakery product, etc. A food product of the present invention may in various forms such as, for example, a liquid, a frozen or semi-frozen liquid, a nutritional supplement, a nutritional bar, a nutritional beverage, a candy bar, a powder (e.g., a beverage powder, etc.), a baked good (e.g., a cookie, a cake, etc.), pudding, sauce, gravy, soup, cake frosting, ice cream, yogurt, milk shake, custard, cheese, cheese spreads, chocolate (e.g., milk chocolate), etc.

For the purposes of the present invention, the term “milk protein based nutritional product” refers to any nutritional product containing milk protein.

For the purposes of the present invention, the term “milk protein” refers to any protein that may be derived from cow's milk, whether or not the protein is actually derived from cow's milk. The term “milk protein” also refers collectively to a mixture of two more milk proteins derived from milk. For example, a “milk protein” may be a mixture of milk proteins.

For the purposes of the present invention, the term “milk protein-based food product” refers to a food product in which the largest source of protein is from milk protein.

For the purposes of the present invention, the term “milk protein ingredient” refers to a milk protein source for a food product of the present invention. For example, a milk protein ingredient may be: casein, caseinate, whey, milk powder, nonfat dry milk, milk protein concentrate, milk protein isolate, etc., or any mixture of two or more milk protein ingredients.

For the purposes of the present invention, the term “milk protein off-note contaminants” refers to cresol, indole, phenol, ethylphenol, methoxyphenol, and skatole, mixtures thereof, conjugates thereof, and mixtures of conjugates thereof.

For the purposes of the present invention, the term “acid casein” refers to casein protein that was precipitated from cow's milk by acidification with either a mineral acid (e.g., hydrochloric acid or sulfuric acid) or an organic acid (e.g., lactic acid).

For the purposes of the present invention, the term “nutritional bar” refers to a nutritional product that is in the form of a bar. Examples of nutritional bars may include Glucerna® Meal Bars and Zone Perfect® Nutrition Bars, available from Abbott Laboratories, Columbus, Ohio, U.S.A.

For the purposes of the present invention, the term “off-note contaminants” refer to cresols, indoles, phenol, ethylphenols, methoxyphenols, skatole, isoflavones, mixtures thereof, conjugates thereof, and mixtures of conjugates thereof. Off-note contaminants cause off-flavors and/or off-odors for proteins.

For the purposes of the present invention, the term “skatole” refers to 3-methylindole and conjugates thereof or mixtures of conjugates thereof.

For the purposes of the present invention, the term “soy protein ingredient” refers to a soy protein source for a food product of the present invention. For example, a soy protein ingredient may be: soy protein isolate, soy protein concentrate, etc. or any mixture of two or more soy protein ingredients.

For the purposes of the present invention, the term “soy protein off-note contaminant markers (OCM)” refers to indole and cresol and isoflavones, mixtures thereof, conjugates thereof, and mixtures of conjugates thereof.

For the purposes of the present invention, the term “soy protein-based food product” refers to a food product in which the largest source of protein is from soy protein.

For the purposes of the present invention, the term “soy protein” refers to any protein that may be derived from soybeans, whether or not the protein is actually derived from soybeans. The term “soy protein” also refers collectively to a mixture of two more soy proteins derived from soybeans. For example, a “soy protein” may be a mixture of soy proteins.

Description

The food products of the present invention may comprise, consist of, or consist essentially of the essential elements and limitations of the invention described herein, as well as any additional or optional ingredients, components, or limitations described herein or otherwise useful in a edible, nutritional or pharmaceutical product.

A problem with current food products, such as nutritional products that include milk proteins or soy proteins, is that such food products sometimes have off odors and/or flavors associated with an unacceptably high presence of “barny” or “cowy” contaminants. However, in the past, there has been a general lack of understanding of the chemical basis for such off odors and/or flavors. A large percentage of the off odors and/or flavors are caused by just a few types of compounds: cresols, indoles, phenol, ethylphenols, methoxyphenols, skatole, isoflavones, and conjugates thereof. The liberation of free cresol and other off-note contaminants during the retort sterilization of nutritional products (and over shelf storage) is largely responsible for the “barny” or “cowy” off-notes which are not uncommon in nutritional beverages made with caseinates, acid casein, nonfat dry milk, or condensed skim milk.

The identification of specific chemical agents responsible for the sensory attributes of milk, cheese, casein, and other dairy products is an active area of research, and many articles have been published in recent issues of prominent food science journals. Some recent articles which associate negative sensory attributes with specific chemical compounds; i.e., “barny” and “cowy” with p-cresol, “dirty” with indole, “fecal” with skatole, and “phenolic” with various aromatic hydrocarbons include: Karagul-Yuceer et al., “Characteristic Aroma Components of Rennet Casein,” J Agric Food Chem, 51(2003) 6797-6801; Bendall, “Aroma Components of Fresh Milk from New Zealand Cows Fed Different Diets,” J Agric Food Chem, 49 (2001) 4825-4832; Karagul-Yuceer, et al., “Volatile Flavor Components of Stored Nonfat Dry Milk,” J Agric Food Chem, 50 (2002) 305-312; Sable et al., “Current Knowledge of Soft Cheeses Flavor and Related Compounds,” J Agric Food Chem, 47 (1999) 4825-4836; Suriyaphan, et al., “Characteristic Aroma Components of British Farmhouse Cheddar Cheese,” J Agric Food Chem, 49(2001)1382-1387, Lopez et al., “Metabolic Conjugates as Precursors for Characterizing Flavor Compounds in Ruminant Milks,” J Agric Food Chem, 41(1993)446-454; Singh, et al., “Flavor of Cheddar Cheese: A Chemical and Sensory Perspective,” Comp Rev Food Sci Food Safety, 2 (2003) 139-162; Drake M A, ADSA Foundation Scholar Award: Defining Dairy Flavors, J Dairy Sci, 87(2004)777-784; O'Connell, et al., “Significance and applications of phenolic compounds in the production and quality of milk and dairy products: a review, Intl Dairy J, 11(2001)103-120; and Bruhn et al., “Milk Flavors: Foreign and chemical flavors.”

These and related articles describe measures that can be implemented to reduce or minimize sensory off-notes in milk and milk products: e.g., maintain adequate ventilation in dairy barns, maintain cow health, use prepared diets as opposed to free range feeding, and maintain sanitary conditions. However, there is no description in these articles of a recommended process for removing the problematic agents present in commercial milk protein ingredients.

In one embodiment, the present invention provides a simple, low cost, and effective means of significantly improving the sensory quality of milk protein based nutritional products. The present invention enables the use of a relatively inexpensive protein source, milk protein isolate (MPI), without compromising the sensory characteristics of nutritional products in which it is used. The concentration of the barny/cowy agent cresol in MPI is typically 10-fold or less than the cresol concentration in currently used milk protein ingredients (including nonfat dry milk, condensed skim milk, acid casein, and calcium and sodium caseinates). The substitution of MPI for the typical milk protein ingredients in a nutritional product often provides significantly improved sensory quality; i.e., with a substantially decreased “barny/cowy” note.

It should be noted that there are different molecular forms of cresol that are present in milk. These forms include free cresol (unbound) and conjugated cresol (bound to a sulfate or to a glucuronate group). Although the “barny” or “cowy” off-note is associated only with free cresol, it is the conjugated forms (cresol sulfate and cresol glucuronate) that are almost exclusively present in raw milk. Pasteurized milk carries little or no “barny” or “cowy” character because its cresol is almost entirely present (greater than 99%) as sulfate and/or glucuronate conjugates. The pasteurization process is sufficiently mild that little or no free cresol is liberated (from the conjugated forms) during the production of retail milk. By contrast, retort sterilization is sufficiently intense that it liberates low but detectable levels of free cresol.

In one embodiment of the present invention, a clean milk protein ingredient may be substituted on a one-for-one basis for “high cresol milk protein ingredients” (caseinates, acid casein, non-fat dry milk (NFDM), condensed skim milk (CSM) in nutritional products, especially in those with a relatively high protein content (i.e., greater than 40 g protein per liter). The substitution of clean milk protein may result in a large decrease in cresol concentration of 90% or more, and therefore a virtual elimination of the “barny” or “cowy” off-note associated with the caseinate protein system. The resulting nutritional products will deliver the same amount of protein without additional cost, and without a “barny” or “cowy” sensory note.

In one embodiment, the present invention employs clean milk protein produced by a process (ultrafiltration, or a similar protein enrichment process) which (coincidental to its objective of enriching protein and removing lactose) substantially decreases the presence of the cresol contaminants (cresol sulfate and/or cresol glucuronate) which are responsible for the “barny” or “cowy” off-note generally associated with retort sterilized nutritional products.

The present invention provides a milk protein based food product with improved flavor and odor. These sensory improvements are obtained by selecting milk protein ingredients whose protein content has been enriched by ultrafiltration or by another process, such as a water washing process of the present invention that reduces the presence of off-note contaminants. A protein enrichment process of the present invention may significantly reduce the concentrations of off-note contaminant carriers, such as the cresol conjugates cresol sulfate and/or cresol glucuronate. Cresol sulfate and cresol glucuronate can impart undesirable sensory properties, such as a “barny” or “cowy” odor and flavor, to the food product, upon release of free cresol (via conjugate hydrolysis) during heat treatment and/or over long-term shelf storage.

Similar problems with off-note contaminants arise with the use of soy protein. In the case of soy protein, cresols, indole, phenol, ethylphenols, methoxyphenols, skatole, and isoflavones act as off-note contaminants. Isoflavones have a “beany” sensory character. Accounts of microbial growth and indole generation associated with soy protein processing, including: U.S. Pat. No. 4,863,613 to Johnson et al., issued Sept. 5, 1989; Maslow, et al., “Relationship Between Indole Production and Differentiation of Klebsiella Species: Indole-Positive and -Negative Isolates of Klebsiella Determined to Be Clonal,” J Clin Microbiol, 31/8 (1993) 2000-2003; and Dakwa, et al., Intl J Food Microbiol, 104/1 (2005) 69-82. Indole and indole derivatives are also synthesized (from the amino acid tryptophan) in many plants (including soy) wherein they serve as growth hormones: Mohammed N, et al., Amino Acids, 24 (2003) 73-80; Tafazoli et al., Chem Res Toxicol, 17 (2004) 1350-1355. There are two sources of the off-note contaminant indole in soy protein ingredients: microbial metabolism of soy protein tryptophan and these growth hormone indoles.

As with milk proteins, clean soy protein may be produced using ultrafiltration to remove the off-note contaminants.

Clean proteins may be produced by ultrafiltration due to the fact that the off-note contaminants are significantly smaller in size than milk proteins and soy proteins. An ultrafiltration enrichment process may selectively remove 90% or more of the off-note contaminants while retaining virtually all of the desirable milk protein or soy protein.

In another embodiment, the clean milk protein of the present invention may be obtained by water washing acid casein. The water washing process significantly reduces the concentrations off-note contaminants cresol, indole, and skatole in the acid casein. In one embodiment, the present invention entails the water washing of acid casein to reduce the concentrations of off-note contaminants which cause sensory off-notes in milk protein. Water washing takes advantage of the fact that the off-note contaminants are generally more soluble in water than acid casein. Such a water washing process provides a simple, low cost, and effective means of significantly improving the sensory quality of a milk protein ingredient and the nutritional product in which such a milk protein ingredient may be used, while still using a relatively inexpensive protein source (acid casein, also called “mineral acid casein”). In one embodiment of the present invention, 1% or less of the total milk protein may be lost using the water washing process of the present invention to produce clean milk protein.

In one embodiment of the present invention, the water washing process for milk protein entails suspending acid casein in water at a temperature of from 220 to 80° C. for a time period of from 15 to 60 minutes. One liter of water is used for every 5 to 20 g of acid casein. After being suspended, the water is drained from the acid casein, thereby removing from 39 to 89% of the off-note contaminants while recovering 99% or more of the milk protein.

The water washing purification process of the present invention takes advantage of the fact that the off-note contaminants are much more water soluble than is the milk protein, such that water washing can selectively remove substantial portions of the off-note contaminants while solubilizing less than 1% of the protein. The water washing process of the present invention may yield a casein protein ingredient that has significantly less “barny”, “cowy”, “dirty”, “fecal”, and “phenolic” character than many commercially available acid casein products. Substantial percentages of the off-note contaminants can be removed in one hour or less, with high protein recoveries. In one embodiment of the present invention, water washing reduces the percentage of off-note contaminants by from 40 to 90% while retaining 99% or more of the milk protein in the acid casein.

The use of the clean milk protein ingredient, e.g., milk protein isolate, of the present invention may be used in commercially available milk protein based nutritional beverages such as: Boost Plus®, available from Novartis and Ensure® and Glucerna® Shakes available from Ross Products Division, Abbott Laboratories, Columbus, Ohio, USA to provide such nutritional products with significantly improved flavor, due to having a substantially reduced decreased cresol and/or indole and/or skatole content. For example, the clean milk protein ingredient of the present invention, may be used in any of the milk protein based nutritional beverage described in U.S. Application Ser. No. 60/673,152, the entire contents and disclosure of which is hereby incorporated by reference.

In one embodiment, the present invention provides a nutritional product. The nutritional products of the present invention include fat, protein, and carbohydrate, each of which is described hereinafter. The concentrations or amounts of each macronutrient in a nutritional beverage of the present invention may vary dramatically depending upon the type of product. Nutritional products of present invention may include nutritional beverages, nutritional bars, nutritional puddings, ice cream, yogurt, etc.

In one embodiment, the present invention provides a milk protein-based nutritional bar with improved flavor that uses clean milk protein. The overall bar flavor may be significantly improved by minimization of protein-bound off-note agents which are known to impart perceptible adverse sensory notes (e.g., “barny”, “cardboardy”, “dirty”) to the nutritional bar. In the context of this proposed application, “clean protein ingredients” are defined as those milk protein ingredients (casein, caseinate, whey, milk powder, nonfat dry milk, etc.) containing less than 1000 μg of p-cresol and less than 100 μg of indole per kg of protein, and as those soy protein ingredients (soy protein isolate and soy protein concentrate, etc.) containing less than 1000 μg of p-cresol, and less than 100 μg of indole, and less than 1000 mg of isoflavones per kg of protein. Protein ingredients that meet these “clean” requirements will impart minimal levels of problematic off-notes to the nutritional bar. It should also be noted that a protein-based nutritional bar, in the context of this application, is a nutritional bar containing at least 17 grams of total protein per 100 grams of bar weight.

A nutritional product of the present invention may comprise milk protein as one of or the only protein within the product, wherein the milk protein represents from 10 to 100%, including from 50 to 95%, and also including from 80 to 90%, by weight of the total protein in the product.

The milk protein ingredient used in milk protein containing product of the present invention is clean milk protein having 10% or less of the off-note contaminant markers (OCM) found in naturally occurring milk proteins. The concentration of milk protein off-note contaminant markers (OCM) per milk protein may be 1100 μg per kg, preferably 600 μg per kg, more preferably 300 μg per kg by weight.

Similarly, a soy protein ingredient used in a soy protein containing product of the present invention has 50% or less of the off-note contaminant markers (OCM) found in acid precipitated soy protein isolates such as Supro 1600™ (Solae, St. Louis, Mo.). The concentration of soy protein off-note contaminant markers (OCM) per soy protein may be 1001 mg per kg, preferably 801 mg per kg, more preferably 501 mg per kg by weight.

A nutritional product of the present invention comprises soy protein as one of or the only protein within the product, wherein the soy protein represents from 10 to 100%, including from 50 to 95%, and also including from 80 to 90%, by weight of the total protein in the product.

Soy protein for use in the nutritional products of the present invention may be derived from soybeans, soy flour, soy protein isolates, or soy protein concentrates.

Other proteins used in a milk protein-based nutritional product of the present invention may come from virtually any type of source, such as animal (e.g., meat, fish), cereal (e.g., rice, corn, wheat), vegetable (e.g., soybean, peanut, pea), or combinations thereof.

Similarly, other proteins that may be used in a soy-based nutritional product of the present invention may come from virtually any source, such as milk (milk protein), animal (e.g., meat, fish), cereal (e.g., rice, corn, wheat), or combinations thereof.

The proteins for optional use in combination with the milk protein component may also include free amino acids known for use in nutritional products, non-limiting examples of which include alanine, arginine, asparagine, carnitine, aspartic acid, cystine, glutamic acid, glutamine, glycine, histidine, isoleucine, leucine, lysine, methionine, phenylalanine, proline, serine, taurine, threonine, tryptophan, taurine, tyrosine, valine, and combinations thereof. These amino acids are most typically used in their L-forms, although the corresponding D-isomers may also be used when nutritionally equivalent. Racemic or isomeric mixtures may also be used.

The nutritional products of the present invention may comprise fat, most typically as emulsified droplets within the finished product. Suitable fats or sources thereof include any that are known for or otherwise safe for use in an oral nutritional products, non limiting examples of which include coconut oil, fractionated coconut oil, soybean oil, corn oil, peanut oil, high erucic acid rapeseed oil, olive oil, safflower oil, high oleic safflower oil, MCT oil (medium chain triglycerides), sunflower oil, high oleic sunflower oil, sesame seed oil, palm and palm kernel oils, palm olein, canola oil, marine oils, cottonseed oils, linseed oils, cocoa butter, and combinations thereof.

The nutritional products of the present invention may comprise, as part of the fat component, polyunsaturated fatty acids, including polyunsaturated fatty acid esters or other natural or synthetic source, including short chain (less than about 6 carbon atoms per chain), medium chain (from about 6 to 18 carbon atoms per chain) and long chain (having at least about 20 carbon atoms per chain) fatty acids having two or more carbon:carbon double bonds, including n-3 (omega-3) and n-6 (omega-6) polyunsaturated fatty acids.

Non limiting examples of polyunsaturated fatty acids suitable for use in the nutritional products of the present invention include alpha-linolenic acid (ALA, C18:3n-3), stearidonic acid (C18:4n-3), eicosapentaenoic acid (EPA, C20:5n-3), docosapentaenoic acid (C22:5n-3), docosahexaenoic acid (DHA, C22:6n-3), linoleic acid (C18:2n-6), gamma-linolenic acid (GLA, C18:3n-6), eicosadienoic acid (C20:2n-6), arachidonic acid (ARA, C20:4n-6), di-homo-gamma-linolenic acid (DGLA, C20:3n-6), and combinations thereof.

The nutritional products of the present invention may comprise a carbohydrate component, which may be almost any type of carbohydrate and may include carbohydrates that are simple, complex, or variations or combinations thereof. Non-limiting examples of carbohydrates include hydrolyzed or modified starch or cornstarch, maltodextrins, glucose polymers (e.g., polydextrose), corn syrup, corn syrup solids, rice-derived carbohydrate, glucose, fructose, lactose, high fructose corn syrup, indigestible oligosaccharides (e.g., fructooligosaccharides), honey, sugar alcohols (e.g., maltitol, erythritol, xylitol, sorbitol), and combinations thereof. Non limiting examples of carbohydrates also include dietary fiber, non-limiting examples of which include gum arabic, carboxymethyl cellulose (e.g., sodium carboxymethyl cellulose), guar gum, citrus pectin, low and high methoxy pectin, oat and barley glucans, carrageenan, psyllium, oat hull fiber, pea hull fiber, soy hull fiber, soy cotyledon fiber, sugar beet fiber, cellulose, corn bran, and combinations thereof.

The nutritional products of the present invention may comprise a flavorant, concentrations of which may vary substantially depending upon the selected flavorant and other ingredients, as well as the desired flavor profile or intensity desired. Any flavorant that is known or otherwise suitable for use in nutritionals or other oral products may be used in the nutritional products herein, provided that such flavorant is also compatible with the other selected ingredients.

Such flavorants may be natural or synthetic and can be provided by a single or multiple flavored materials. Flavorants for use in the nutritional products are most typically a combination of many ingredients to provide the desired flavor association.

Non-limiting examples of suitable flavorants include enzyme-modified flavors (e.g., dairy flavors), fermentation flavors (e.g., dairy flavors), reaction flavors (e.g., chocolate, caramel), natural extracts (e.g., vanilla, coffee, chocolate), and combinations thereof. Preferred for use herein include chocolate flavor, vanilla flavor, and combinations thereof.

Non-limiting examples of other specific flavorants suitable for use herein may include butter pecan flavor, orange, lemon, lime, apricot, grapefruit, yuzu, sudachi, apple, grape, strawberry, pineapple, banana peach, melon, apricot, ume, cherry, raspberry, blueberry, butter, vanilla, tea, coffee, cocoa or chocolate, mint, peppermint, spearmint, Japanese mint, asafetida, ajowan, anise, angelica, fennel, allspice, cinnamon, camomile, mustard, cardamon, caraway, cumin, clove, pepper, coriander, sassafras, savory, Zanthoxyli Fructus, perilla, juniper berry, ginger, star anise, horseradish, thyme, tarragon, dill, capsicum, nutmeg, basil, marjoram, rosemary, bayleaf, wasabi, beef, pork, chicken, fish, crustacean, dried and smoked fish, seaweed, wine, whisky, brandy, rum, gin, liqueur, floral flavors, onion, garlic, cabbage, carrot, celery, mushroom, tomato, and combinations thereof.

The nutritional products of the present invention may further comprise other optional components that may modify the physical, chemical, aesthetic or processing characteristics of the products or serve as pharmaceutical or additional nutritional components when used in the targeted population. Many such optional ingredients that are known or otherwise suitable for use in other nutritional products may also be used in the products herein, provided that such optional ingredients are safe and effective for oral administration and are compatible with the essential and other ingredients in the selected product form.

Non-limiting examples of other optional ingredients include preservatives, emulsifying agents, buffers, antioxidants, pharmaceutical actives, sweeteners including artificial sweeteners (e.g., saccharine, aspartame, acesulfame K, sucralose), colorants, additional flavors, thickening agents and stabilizers, and so forth.

The nutritional products of the present invention may further comprise vitamins or related nutrients, non-limiting examples of which include vitamin A, vitamin C (e.g., ascorbic acid which may also function as an antioxidant), vitamin D, vitamin E, vitamin K, thiamine, riboflavin, pyridoxine, vitamin B₁₂, carotenoids (e.g., beta-carotene, zeaxanthin, lutein, lycopene), niacin, folic acid, pantothenic acid, biotin, choline, inositol, salts/conjugates and derivatives thereof, and combinations thereof.

The nutritional products may further comprise minerals, non-limiting examples of which include iron, phosphorus, magnesium, zinc, manganese, sodium, potassium, molybdenum, chromium, chloride, etc., and combinations thereof.

The nutritional products may further comprise a calcium-containing material, examples of which include any calcium source that is known for or otherwise safe and effective for use in an oral product, including calcium chloride, calcium citrate, calcium malate, calcium citrate malate, calcium carbonate, tricalcium phosphate, and so forth.

The nutritional products of the present invention may be prepared from the various components by any known or otherwise effective manufacturing technique for preparing a liquid nutritional formulation. Many such techniques are known in the nutrition and formulation arts and can easily be applied by one of ordinary skill in the art to the nutritional products described herein.

In one embodiment, a nutritional beverage of the present invention may be prepared by first forming an oil and fiber (if any) blend containing all formulation oils, any emulsifier, any fiber and fat-soluble vitamins. Additional slurries (typically a carbohydrate and up to about two protein slurries) are prepared separately by mixing the carbohydrate and minerals together and mixing the protein in water. The slurries are then mixed together with the oil blend. The resulting mixture is homogenized, heat processed, standardized with any water-soluble vitamins, flavored and the liquid terminally sterilized or aseptically filled.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

All numerical ranges as used herein, whether or not expressly preceded by the term “about”, are intended and understood to be preceded by that term, unless otherwise specified.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The nutritional products of the present invention may also be substantially free of any optional ingredients described herein. In this context, the term “substantially free” means that the selected composition contains less than a functional amount of the optional ingredient, including zero percent by weight of such optional ingredient.

### EXAMPLES

### Example I

Clean milk protein ingredients and soy protein ingredients in accordance with the present invention are produced by a washing purification method of the present invention. Examples of these ingredients are listed in Table 1 below:

TABLE 1

| | | | | Isoflavones, |
|---|---|---|---|---|
| | | Total | Free | mg/kg |
| | | p-Cresol, | Indole, | protein |
| Sample | | μg/kg | μg/kg | (aglycone |
| No. | Protein Ingredient | protein | protein | total) |
| 1 | Milk Protein Isolate, 85% | 200 | <100 | <1 |
| | protein, Supplier A | | | |
| 2 | Milk Protein Isolate, 85% | 900 | 20 | <1 |
| | protein, Supplier B | | | |
| 3 | Whey Protein Concentrate, | 300 | 16 | <1 |
| | 80% protein, Supplier C | | | |
| 4 | Whey Protein Concentrate, | 540 | 6 | <1 |
| | 80% protein, Supplier D | | | |
| 5 | Soy Protein Isolate, 85% | 160 | 16 | 700 |
| | protein, Supplier E | | | |
| 6 | Soy Protein Isolate, 85% | 90 | 15 | 370 |
| | protein, Supplier F | | | |

### Example II

Nutritional bars in accordance with the present invention are made using the milk protein and soy protein ingredients of Example 1. In some cases, (Products 3, 4 and 5) a mixture of soy protein and milk protein ingredients of Example 1 are used. Examples of these nutritional bars are listed in Table 2 below:

TABLE 2

| | | | | Total |
|---|---|---|---|---|
| | Protein | Protein | Protein | Protein, |
| Nutritional | Ingredient | Ingredient | Ingredient | g/100 g |
| Bar | #1 | #2 | #3 | of Bar |
| 1 | MPI A, at | None | None | 17 |
| | 20 g per | | | |
| | 100 g of bar | | | |
| 2 | SPI E, | None | None | 21 |
| | 25 g per | | | |
| | 100 g of bar | | | |
| 3 | WPC C, | SPI F, | None | 18 |
| | 10 g per | 12 g per | | |
| | 100 g of bar | 100 g | | |
| | | of bar | | |
| 4 | WPC D, | SPI E, | None | 25 |
| | 15 g per | 15 g per | | |
| | 100 g of bar | 100 g | | |
| | | of bar | | |
| 5 | MPI B, | WPC C, | SPI, | 25 |
| | 10 g per | 10 g per | 10 g per | |
| | 100 g of bar | 100 g | 100 g | |
| | | of bar | of bar | |

### Example III

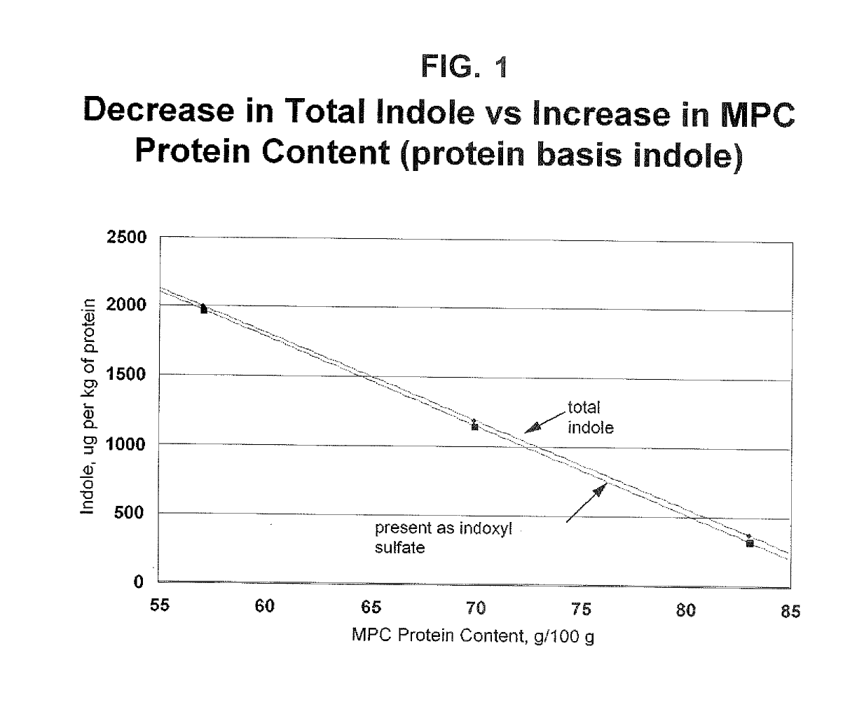

Measurable levels of the indole conjugate indoxyl sulfate are extracted from a selection of milk protein ingredients, as shown in Table 3 below. A ppb presence of indoxyl sulfate in cows' milk has been known for many years. Indole is an intestinal bacterial metabolite of tryptophan; free indole is converted to indoxyl sulfate (which facilitates its excretion) in the liver. The relevance of indoxyl sulfate to RPD nutritionals is two-fold: (a) the release of free indole (from indoxyl sulfate) during heat treatment and/or over shelf storage can impart a dirty note to liquid nutrionals; and (b) the indoxyl sulfate content of MPC decreases as the protein content increases as shown in FIG. 1. Therefore, the conjugate is sufficiently water soluble that its concentration may be significantly reduced by ultrafiltration or by water washing.

TABLE 3
Indoxyl Sulfate in Milk Protein Ingredients

| | | as μg/kg | as % of |
|---|---|---|---|
| Sample No. | Milk Protein Ingredient | (ppb) | total indole |
| 1 | ACID CASEIN | 20,900 | 98% |
| 2 | ACID CASEIN | 2160 | 93% |
| 3 | ACID CASEIN | 1670 | 91% |
| 4 | CaCASEINATE | 1810 | 94% |
| 5 | CaCASEINATE | 381 | 84% |
| 6 | MPC, 57% protein | 2040 | 99% |
| 7 | MPC, 70% protein | 1460 | 97% |
| 8 | MPC, 83% protein | 494 | 87% |
| 9 | MPI | 309 | 73% |

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A food product comprising:
milk protein; and
one or more other food ingredients, wherein the food product contains 1100 μg or less of off-note contaminant markers per kg of milk protein.

2. The food product of claim 1, wherein the product is a nutritional product.

3. The food product of claim 2, wherein the product is a nutritional beverage.

4. The food product of claim 2, wherein the product is a nutritional bar.

5. The food product of claim 1, wherein the product is a beverage.

6. The food product of claim 1, wherein the product is a solid food.

7. The food product of claim 1, wherein the one or more other food ingredients comprise one or more fats.

8. The food product of claim 1, wherein the one or more other food ingredients comprise one or more carbohydrates.

9. The food product of claim 1, wherein the one or more other food ingredients comprise one or more proteins.

10. The food product of claim 1, wherein the food product contains 1000 μg of p-cresol per kg of milk protein.

11. The food product of claim 1, wherein the food product contains 100 μg of indole per kg of milk protein.

12. The food product of claim 1, wherein milk protein comprises from 50 to 95% by weight of the total protein in the product.

13. The food product of claim 1, wherein milk protein comprises from 80 to 90% by weight of the total protein in the product.

14. The food product of claim 1, wherein the food product contains 600 μg or less of off-note contaminant markers per kg of milk protein.

15. The food product of claim 1, wherein the food product contains 300 μg or less of off-note contaminant markers per kg of milk protein.

16. A method comprising the following steps:
(a) providing an impure ingredient comprising milk protein and one or more milk protein off-note contaminants; and
(b) water washing the impure ingredient to thereby form a purified food ingredient containing less than 1100 μg or less of off-note contaminant markers per kg of milk protein, wherein the impure product contains more than 1100 μg of off-note contaminant markers per kg of milk protein.

17. The method of claim 16, wherein the impure ingredient is acid casein.

18. The method of claim 17, wherein step (b) comprises the following steps:
(c) suspending the acid casein in water;
(d) removing the water to thereby remove the milk protein off-note contaminants while recovering 99% or more of the milk protein in the acid casein.

19. The method of claim 18, wherein the water temperature of step (c) is from 220 to 80° C.

20. The method of claim 19, wherein the acid casein is suspended in the water in step (c) for from 15 to 60 minutes.

21. The method of claim 18, wherein the ratio of acid casein to water in step (c) is from 5 to 20 g of acid casein to 1 L of water.

22. The method of claim 16, wherein from 39 to 89% of the off-note contaminants are removed by step (b).

23. The method of claim 16, wherein the food product contains 600 μg or less of off-note contaminant markers per kg of milk protein.

24. The method of claim 16, wherein the food product contains 300 μg or less of off-note contaminant markers per kg of milk protein.

25. A food product comprising:
soy protein; and
one or more other food ingredients, wherein the food product contains 1001 μg or less of off-note contaminant markers per kg of soy protein.

26. The product of claim 25, wherein the product is a nutritional product.

27. The product of claim 26, wherein the product is a nutritional beverage.

28. The product of claim 26, wherein the product is a nutritional bar.

29. The product of claim 25, wherein the product is a beverage.

30. The product of claim 25, wherein the product is a solid food.

31. The product of claim 25, wherein the one or more other food ingredients comprise one or more fats.

32. The product of claim 25, wherein the one or more other food ingredients comprise one or more carbohydrates.

33. The product of claim 25, wherein the one or more other food ingredients comprise one or more proteins.

34. The food product of claim 25, wherein the food product contains 1000 mg of isoflavones per kg of soy protein.

35. The food product of claim 25, wherein the food product contains 100 μg of indole per kg of soy protein.

36. The food product of claim 25, wherein soy protein comprises from 50 to 95% by weight of the total protein in the product.

37. The food product of claim 25, wherein soy protein comprises from 80 to 90% by weight of the total protein in the product.

38. The food product of claim 25, wherein the food product contains 801 μg or less of off-note contaminant markers per kg of soy protein.

39. The food product of claim 25, wherein the food product contains 501 μg or less of off-note contaminant markers per kg of soy protein.
